(19) United States
(12) Patent Application Publication
(10) Pub. No.: US 2022/0309370 A1
(43) Pub. Date: Sep. 29, 2022

(54) Computationally Efficient System And Method For Observational Causal Inferencing

(71) Applicant: Amplitude, Inc., San Francisco, CA (US)

(72) Inventors: Zachary Mason, San Francisco, CA (US); Scott Kramer, New York City, NY (US)

(21) Appl. No.: 17/214,379

(22) Filed: Mar. 26, 2021

(51) Int. Cl. G06N 5/04; G06N 5/00; G06K 9/62; G06F 11/34

(52) U.S. Cl. CPC G06N 5/046; G06N 5/003; G06K 9/6234; G06F 11/3438

(57) ABSTRACT

A method and system are provided for performing causal inferencing in a computationally efficient manner. In one embodiment, a computer-implemented method includes collecting user interaction data for a plurality of users, within a specified observation window. The collected data comprises a treatment observation for at least one user and an outcome observation for at least one user. Memory for a feature table is allocated, wherein a size the allocated memory is proportional to a number of features in the collected data. Feature-related values are stored in the feature table based on respective pre-treatment observation periods for each of the plurality of users. A selected number of confounders are identified from the feature table. An effect of the treatment is computed on the outcome using the selected confounders.

### FIELD

This disclosure generally relates to causal inferencing from observational data and, in particular, to computationally efficient techniques for such inferencing from users' online or in-app interactions.

### BACKGROUND

It is well known that correlation does not necessarily imply causality. For example, it has been observed that crime goes up when ice cream sales go up, but buying ice cream generally does not cause crime. Both may be causally related to higher temperatures, however. Unfortunately, correlation is often all that one can observe and measure directly from the available data within which causation is to be inferred. In some cases, such inferencing is feasible under special circumstances. The set of causal relationships specified over a variable space is usually called a causal graph. Many techniques for deriving causal graphs are computationally expensive in that they can have factorial time complexity, usually rendering them impractical for sets of 10-15 (or more) variables. In some cases, such as in big data analysis, e-commerce, and scientific exploration, the number of variables can be 10,000 or more. As such, the time required to run a typical causal graph discovery algorithm to analyze such cases would dwarf the total lifetime of the universe!

An approach that is commonly taken to perform causal inferencing in some situations is to conduct controlled experiments. This too, however, is impractical in many cases as there are many constraints on the actions an analyst can take with respect to observing and collecting the necessary data. Also, with the increasing number of variables, the number of experiments needed to facilitate causal inferencing can grow exponentially, making them prohibitively expensive in terms of cost and/or time.

### SUMMARY

Methods and systems for performing causal inferencing in a computationally efficient manner are disclosed. In one embodiment, a method includes collecting user interaction data for a plurality of users, within a specified observation window. The collected data comprises a treatment observation for at least one user and an outcome observation for at least one user. Memory for a feature table is allocated, wherein a size the allocated memory is proportional to a number of features in the collected data. Feature-related values are stored in the feature table based on respective pre-treatment observation periods for each of the plurality of users. A selected number of confounders are identified from the feature table. An effect of the treatment is computed on the outcome using the selected confounders.

### BRIEF DESCRIPTION OF THE DRAWINGS

The present embodiments will become more apparent in view of the attached drawings and accompanying detailed description. The embodiments depicted therein are provided by way of example, not by way of limitation, wherein like reference numerals/labels generally refer to the same or similar elements. In different drawings, the same or similar elements may be referenced using different reference numerals/labels, however. The drawings are not necessarily to scale, emphasis instead being placed upon illustrating aspects of the present embodiments. In the drawings:

FIG. 1 is a flow chart of a feature engineering process, according to one embodiment;

FIG. 2 schematically depicts a storage structure for storing a feature table, according to one embodiment;

FIG. 3 is a flow chart of a confounder selection process, according to one embodiment;

FIG. 4 is a flow chart of a treatment effect estimation process, according to one embodiment;

FIG. 5 illustrates an exemplary user interface for identifying latent confounding variables that can impact an outcome, according to one embodiment;

FIG. 6 is a block diagram of a causal inferencing system, according to one embodiment.

### DETAILED DESCRIPTION

The following disclosure provides different embodiments, or examples, for implementing different features of the subject matter. Specific examples of components and arrangements are described below to simplify the present disclosure. These are merely examples and are not intended to be limiting.

### Theoretical Framework

Techniques described herein facilitate computationally efficient causal inferencing. These techniques do not rely on specially designed experiments. Rather, they use observational data. In order to address the problem of having to analyze several (e.g., tens, hundreds, thousands, or more) variables, various embodiments take advantage of the fact that under many circumstances, the observed data is sequential, in that one event, should it occur, necessarily follows another which, should it occur, necessarily follows yet to another event. This allows performing the analysis of causation in terms of entropy flows rather than having to discover direct causal links. In information theory, entropy, as further described below, is a measure of unpredictability of an event. An entropy flow can indicate how the unpredictability of one event can impact the entropy/unpredictability of another.

The conventional causal graph discovery algorithms are generally concerned with discovering the causal links, in terms of both their existence and their direction, between all the nodes in the graph. These algorithms typically assume that the full set of variables in the underlying graph is known. In the real world, this assumption is almost always false; the true set of variables describing a real-world process to be analyzed is generally complex where complete knowledge of all the variables involved is likely not available.

The system described herein does not attempt to find or analyze causal links directly. Instead, the present system is concerned with flows of information through the causal graph. The present system is built on the assumption, which is shown to be true usually, that there can be hidden variables and an intricate structure underlying even the most superficially simple causal relationships. While identifying all the hidden variables and causal relationships therebetween can be impractical, if not infeasible, the flows of information associated with such variables can be determined. Like causal relationships, causal information only flows one way. As such, a downstream node in a causal graph or event graph can be understood as a function of its immediate upstream parents. While a causal link is just a directed edge between two nodes in a graph, a causal information flow (also referred to as entropy flow) typically acts more like water flowing downstream in that the entropy flow can branch and be diluted by other entropy flows.

One of the primary goals of causal analysis is identifying confounding variables. Suppose there are two variables X and Y which are dependent, i.e., information about the state of one (X or Y) can be gleaned from the state of the other (Y or X). This can be explained by a causal relationship between the two in either direction, or it can be explained by a confounding variable, say U, having a causal influence on both X and Y. Referring to the ice cream and crime example above, “summer” can be a confounding variable for both “ice cream sales” and “crime.” If the analysis is conditioned on the knowledge of the existence of summer, the unconfounded relationship (if any) between ice cream and crime can be determined.

Suppose, however, that the summer variable was, for some reason, unobservable. In this case, it would not be possible to condition the analysis on the knowledge of the existence of summer. It can suffice, however, to condition the analysis on another variable that is both observable and has the same information as the variable summer, such as “geese migrating south,” for instance. It should be noted that summer may have an influence on ice cream and crime, but is not solely determinative of either of them. The same may be true of the variable “geese migrating south.” In effect, geese migrating can be a proxy for summer, even though, unlike summer, it has no causal influence on crime or ice cream. The overall technique described herein does not attempt to prove that summer->crime (i.e., crime is causally linked to summer). Rather, it just tries to find observable proxies for confounders, such as geese-migration.

Causal discovery is difficult because dependence is observable but causality is not. Therefore, the problem is that X causally influencing Y (written X->Y) generally manifests statistically as a dependency between X and Y, but Y->X, or U->X, U->Y also manifest the same way. Therefore, from this information alone, a system cannot readily determine whether X causally influences Y or Y causally influences X, or some other variable U causally influences X and Y both. This symmetry can be resolved using colliders. A collider is a node C such that A->C and B->C. Uniquely among all causal graph topologies, colliders have the property: dep(A, B) <dep(A, BIC). That is, conditioning on C actually increases the dependency between A and B.

Consider the following example: Let C be “car does not start,” and A=“out of gas” and B=“battery dead.” Suppose A and B are the only two reasons or causes of C. In ordinary circumstances, out of gas and battery dead are independent, i.e., dep(A,B)=0. But if it is known that the car does not start, then it has to be one or the other of A and B. As such, if it is known that the battery is not dead, then a system would determine the car is out of gas. Thus, via conditioning over C, the variables A and B have become dependent, i.e., dep(A, BIC)>0. In information theoretic terms, the mutual information (MI) of A, B and C is negative, i.e., MI(A, B, C)<0. If MI(A, B)=0, then C is the collider, which implies not that A and B both are upstream of C necessarily, but that A and B are in entropy flows which originate upstream of C, A, and B. This is equivalent to C not being upstream of both A and B. The relationships between C and A and C and B are referred to as R-links.

Suppose the goal is to determine the causal impact of a treatment T on an outcome O. In an ideal world, all the confounding variables of T and O would be known though in reality this is unlikely. Nevertheless, based on the framework described above, it is sufficient to identify all of the confounding entropy flows associated with T and O, even when all the confounding variables are not known. Thus, if MI(T,O) is known, the goal becomes identifying as many of the confounding entropy flows as possible, and to determine non-confounding, causal entropy flows between T and O. In this analysis, synthetic confounding variables can be constructed and used similarly as unsynthesized or original confounding variable are. For example, using original confounding variables X and Y, new synthetic confounding variables, such as X-before-Y, Y-before-X, etc. can be created. This allows causal systems to represent and exploit sequencing information that is otherwise invisible.

To identify confounding entropy flows, nodes upstream R-linked to T and O can be identified by finding colliders. In particular, we can identify confounding entropy flows by finding nodes R-upstream of both T and O. We can then identify true causal entropy by finding nodes R-upstream of o, but R-downstream of T. This can be achieved by finding a collider C and a conditioning set S such that MI(T, O|S)=0 and MI(T, O, C|S)<0. If a node C is proven R-upstream of both T and O, then it is necessarily a proxy for an entropy flow whose true causal influence is MI(C, O|T), and whose confounding influence is MI(C, O)—MI(C, O|T). If T>ᵣC>ᵣ O, T is R-upstream to C, but C is R-upstream to O, then the true causal influence between T and O that touches C is just MI(T, C, O). Thus, if there is a set of intermediate nodes of this kind, i.e., T>ᵣCᵢ>ᵣO for each Cᵢ, then the total true causal influence is ΣᵢMI(T,Cᵢ,O|C_{j<i}), where C_{j<i} for a particular i represents all Cⱼ>ᵣCᵢ.

Such a set can be found by performing a heuristic search over all the possibilities for T, O and S based on their MI with respect to T, O and each other. Such a search can be computationally efficient because it generally depends linearly, and not super linearly, exponentially, or factorially, on the variable space. The search can be optimized further as the heuristics can guide the search to the relevant portion of the search space, i.e., to the confounding variables that are significant.

In general, the total MI between T and O is known, and the techniques described herein can partition this entropy between causal and confounding sets. Therefore, at any given point during execution of an implementation of the overall technique, how much of the total entropy has been successfully partitioned can be readily determined. In some cases, this provides a stopping criterion. For example, the analysis can be terminated when the total unresolved entropy falls below a specified, tolerable threshold (e.g., less than 20%, 10%, 5%, 2%, etc. of the total entropy). This makes some embodiments of the overall technique further efficient computationally because, unlike some other techniques, which cannot be terminated in a similar manner, these embodiments can be terminated to conserve computational resources, and they can nevertheless provide substantial causal inferences. The theoretical technique described above, which analyzes flows of causal and confounding information, can also be used to determine a sufficient set of conditioning variables while analyzing the effect of treatment on an outcome (though it also inform a sophisticated model of interactions of variables in the observation space).

### Implementations

Various embodiments described herein feature a technique to perform observational analysis in order to estimate the causal effect of a treatment on an outcome with respect to an item of interest, which can be a product, a service, an expressed opinion, etc., where the analysis does not rely on and excludes a randomized controlled experiment. The overall technique includes three major steps: (i) feature engineering, (ii) selection of confounding variable(s), and (iii) estimation of treatment effect. Various implementations of one or more of these majors steps can minimize the requirement of computing resources. In general, computing resources include one or more of number of processors/cores, processor time, overall computation time, memory capacity, peak power required, or total energy required.

One aspect of product analytics is understanding how performing an action with respect to the product (an item of interest, in general) may lead to a user eventually undertaking a subsequent action, or may lead to the user not undertaking a particular action, with respect to a key product objective. For example, it may be desirable to understand with respect to a website for selling jewelry, whether capturing the image of the user and displaying the jewelry item on the user's face leads to an increase in the sale of jewelry items. Likewise, in a large and complex user interface, such as that used to operate a power plant, it may be desirable to understand whether flashing a warning in a particular location in a particular manner causes a plant operator to take a safety-related action. In order to estimate such a causal effect, which can be described generally as the effect of an action with respect to an item of interest on a key objective associated with the item of interest, an analyst can perform an A/B test. In general, A/B testing involves presenting to a user two options: A and B, where in only one option an action (also referred to as treatment) with respect to an item of interest is taken. By comparing respective user actions/inactions (also referred to as outcomes) under the options A and B, a causal relationship, if any, can be inferred between the treatment and outcomes. Performing A/B testing is not practical, however, for every possible combination of treatment and outcome, with respect to an item of interest.

An analyst can perform causal inferencing, generally understood as deriving a causal relationship, if any, between a treatment and outcome, without running an experiment (such as the A/B test) and, instead, via an observational study. Many existing techniques that can infer a causal relationship have O (N!) complexity, where N is the number of variables that can affect an observed outcome. In other words, the required computational resources generally scale at the rate of N!. The number of variables can range a from a few, to a tens, to hundreds, to thousands and, since the scaling of computation resources is proportional to N!, a typical computing system can be overwhelmed and may run out of processing and/or memory capacity, and/or may take excessively long (e.g., several hours or even days) to perform the analysis.

Various embodiments described herein are computationally efficient, in that their runtime complexity is O (N) as opposed to O (N!) and, as such, execution of the processes discussed below may require substantially less, e.g., one or two magnitudes of order less, number of processors/cores, processing time, memory, overall computation time, peak power, and/or energy consumed. For example, if the number of variables N (generally actions or events that may potentially influence an outcome, as discussed below) that are to be analyzed changes from 10 to 30, according to a conventional technique, the processing requirements may increase by a factor of about 10²⁵. In other words, the required memory and processing capacity may increase 10²⁵ fold. In contrast, according to the embodiments described herein, the processing requirements may only increase by a factor of three. This computationally efficient process includes three major steps: (i) feature engineering, (ii) selection of confounding variable(s), and (iii) estimation of treatment effect, each of which is discussed below.

### Major Step 1: Feature Engineering

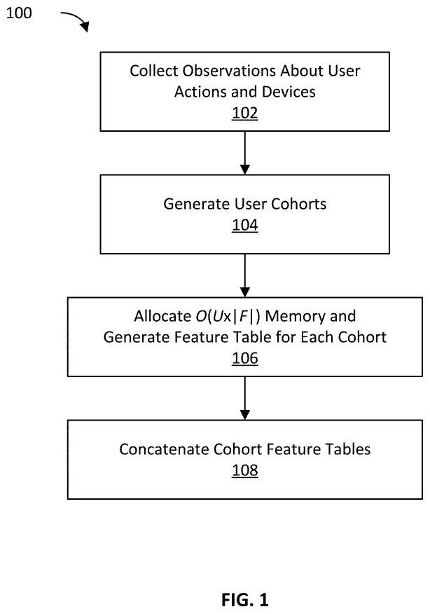

FIG. 1 is a flow chart illustrating a process 100 of feature engineering. In general, a feature is an action a user may take, or fail to take, with respect to the information displayed to a user in connection with an item of interest. For example, if the item of interest is a product offered for sale, the product and an offer therefor may be displayed on a webpage. The item of interest can also be a service offered on a webpage, user response or reaction, such as a comment posted on a social media platform, forwarding a link to another user, etc., or a user action or inaction in a gaming platform or a user interface. Examples of such actions include, but are not limited to scrolling the displayed, zooming in or out the display, mouse-over over a particular region of the display, clinking a button or an image provided in the display, closing or navigating away from the display, playing media regarding an item of interest, effecting an alteration in a database regarding the item of interest, etc. The observation-based feature engineering generally involves collecting observations about user actions (such as, e.g., webpage interactions, mobile app interactions, user-interface interactions, etc.) and user devices, where such observations includes features, at step 102. The observations may also include one or more properties of the user device, such as the type of the device, the type of the operating system, the location of the device, etc. The observations are generally collected before a particular treatment and in response to the treatment, and may include the desired or expected outcome. In particular, the observations are collected during a specified or selected time window (also called observation window), the length of which can be a few minutes, a couple of hours, a day, several days, or longer.

A treatment, in some cases, is a stimulus provided to the users, such as a displayed offer for sale, display of information (e.g., in a pop-up window) about an item of interest, a warning or notice, etc. A treatment can also be a triggering action taken by the user. For example, a user may be interested in searching for a particular product or service, or may be interested in learning about or purchasing a particular product or service. As such, a user may enter a search query in the browser or click or tap a button, link, or image on a webpage or a mobile app. The expected or desired outcome in general, is user action or inaction, such as clicking or tapping on a link or displayed image or button, adding the item of interest to an online shopping car, providing credit card information, providing personal information (e.g., address, age, gender, etc.), searching for an alternative to the item of interest, purchasing the item of interest, commenting with respect to the item of interest (such as indicating a like or dislike, which may include rating, e.g., by designating stars, for the item of interest), forwarding a link associated with the item of interest to another user, etc. An action or inaction that is an expected or desired outcome (also referred to as just outcome, for brevity) may be taken (or not taken) in response to a provided stimulus or upon a triggering action by the user. For example, upon indicating the desire to purchase a product (e.g., by clicking on a button “Add to Cart”), the user may ultimately complete the purchase by clicking on a button “Place Order.” In this example, clicking the “Add to Cart” button can be a treatment and clicking the “Place Order” button can be the outcome. Other actions in between, such as filling out a form requesting personal information are examples of features. in general an outcome can be any state, condition, or event of interest, and a treatment can be any action that conceivably has an impact on the outcome.

After the observations are collected for several users, in step 104 four cohorts of users are generated as follows:
1. User who did not receive/perform the treatment, and did not provide an outcome;
2. Users who did not receive/perform the treatment, but did provide the outcome;
3. Users who received/performed the treatment but did not provide the outcome; and
4. Users who received the treatment/performed, and provided the outcome.
   For all the users, the collected observations include pre-treatment observations, or the observations collected from the beginning of the observation window up to the point in time within the window at which the treatment was first provided/performed. Since some users are never provided with or perform the treatment, the pre-treatment observation window for such users is the entire observation window. Thus, the length of the pre-treatment observation window is a fraction of the length of the observation window. The fraction can vary from 0%, for users who receive or perform the treatment at the beginning of the observation window to 100%, for users who do not receive or perform the treatment during the observation window.

Thereafter, in step 106, a feature table is generated for each cohort. The feature table may be stored in memory as an array, a matrix, or three or more dimensional tensor. To this end, memory for a data structure is allocated for and associated with each user, in step 106. Generally, the data structure associated with an individual user is part of a collective data structure (e.g., an array, matrix, or a tensor), allocated for all the users observed during the observation window. The data structure associated with an individual user includes (|F|=|E|+|P|) elements, where F is the set of observed features and |F| is the total number of observed features. The set of observed features may include one or more events or user actions and/or one or more properties of devices of the users (also called user properties). Thus, E is the set of observed events, |E| is the total number of observed events, P is the set of observed properties of the user device, and |P| is the total number of observed properties. The memory requirement according to this scheme is efficient because it grows not exponentially or with a power factor of greater than one, but linearly with the number of observed features and properties, and the number of users. Thus, this memory allocation scheme may require significantly less memory (e.g., several magnitudes of order less) compared to some other causal inferencing techniques.

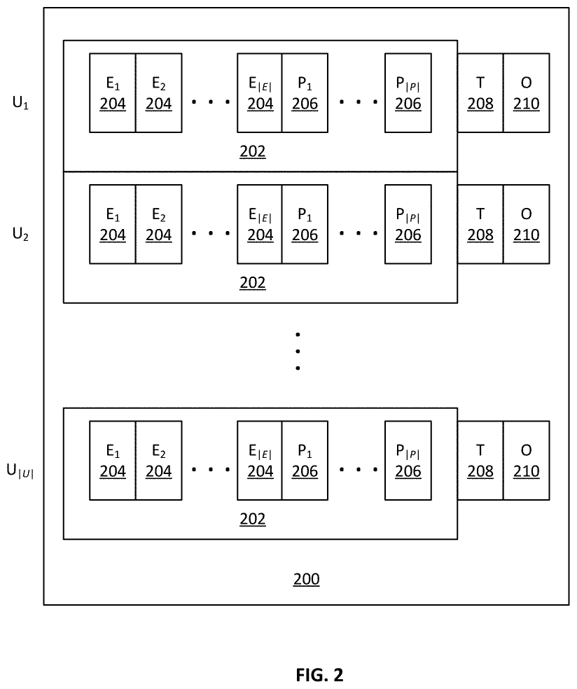

FIG. 2 schematically depicts an overall storage structure 200 that may be allocated in memory for storing observations. The size of the storage structure 200 is O (|U|×|F|)=O (|U|×(|E|+|P|)), where |U| is the number of users observed during the observation window, |E| and |P| are described above. For each observed user, the overall storage structure 200 includes a data structure 202 having |E| elements 204 for storing occurrences or non-occurrence of the observed events. The data structure 202 also includes |P| elements 206 for storing the observed properties of users' devices. In addition, the data structure 202 includes an element 208 for an indication of the provisioning of or performance of the treatment and an element 210 for an indication of the performance of the outcome. The overall storage structure may be implemented as an array, a matrix, a multi-dimensional tensor, a hash table, etc.

An example of a feature table, according to one embodiment, is shown as Table 1 below. In various embodiments, creating a feature table for a particular cohort includes creating various columns where each row corresponds to a particular user within the cohort. Some columns correspond to different observed features (also referred to as tracked or observed events), one column corresponds to the provided or performed treatment, and one column corresponds to the outcome. In various embodiments, these columns are Boolean. A Boolean column corresponding to an event (e.g., “didEventA”) indicates, in different rows, whether the corresponding users performed that event. The Boolean column corresponding to the treatment (e.g., “didTreatment”) indicates, in different rows, whether the corresponding users received or performed the treatment. The Boolean column corresponding to the outcome (e.g., “didOutcome”) indicates, in different rows, whether the corresponding users performed the outcome (the desired or expected action). For each property observed, a respective column (e.g., “platform”) is created where, in different rows, the latest values of that property for the corresponding uses are stored. In creating the feature table, only the observations from the users' respective pre-treatment observation windows are used. The feature tables for the four different cohorts may be concatenated in step 108 (FIG. 1), to provide a comprehensive feature table for all observed users.

TABLE 1
Example Feature Table

| userld | didEventA | didEventB | platform | didTreatnnent | didOutconne |
|---|---|---|---|---|---|
| 1 | True | True | Web | 1 | 0 |
| 2 | False | False | iOS | 1 | 0 |
| 3 | False | False | iOS | 1 | 1 |
| 4 | False | True | Android | 0 | 1 |
| 5 | False | True | Web | 0 | 0 |
| 6 | True | False | iOS | 0 | 0 |

### Major Step 2: Confounding Variable Selection

The second major step of the overall causal inferencing technique is to determine the confounding variables that may be used derive causal inference(s). The events or features and the properties in the feature table are all considered as confounding variables in this step. Since the columns of a feature table are generated using pre-treatment observations only, it can be assumed that the entropy flow from these confounding variables is predecessor to the entropy flow between the treatment and outcome. In general, the entropy of a random variable can indicate the unpredictability of the random variable. Mutual information (MI) between two random variables measures how much information one random variable represents, on average, about another. Conditional MI is the MI between two random variables given the value (or occurrence) of one or more additional random variables.

Given a feature table, choosing an optimized set of N confounding variables can be described as the selection of confounding variables that maximize:

$${\sum }_{i = 1}^{N} MI ( {C}_{i} , O \vert T , C / {C}_{i} )$$

where
N≤|F|; |F| being the total number of observed features, as described above;
Cᵢ is the i-th confounding variable, represented by a corresponding feature or property column of the feature table;
C is the set of all confounding variables, and C/Cᵢ is the set of all confounding variables except
Cᵢ;
O is the outcome variable (or just outcome), represented by the outcome column of the feature table; and
T is the treatment variable (or just treatment), represented by the treatment column of the feature table.

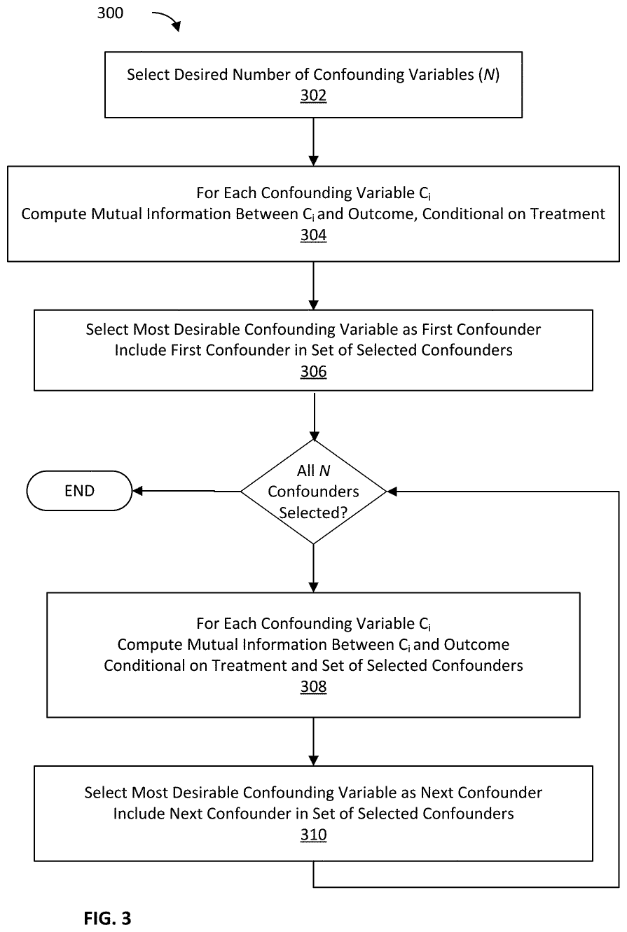

FIG. 3 illustrates a process 300 that uses the equation above to select the best confounding variables, in a computationally efficient manner. At step 302, the desired number of confounding variables N is selected. The total number of observed features is |F|. As such, N can be any number (e.g., 1, 3, 8, 20, etc.), as long as N≤|F|. At step 304, for all possible Cᵢ, MI (Cᵢ, O|T) is computed where 1≤i≤|F|. For the i-th confounding variable Cᵢ, MI (Cᵢ, O|T) provides a measure of information that Cᵢ represents about the outcome, given the treatment as occurred. As such, the Cᵢ that maximizes MI (Cᵢ, O|T) (can be referred to as the most suitable or desirable confounding variable) is chosen as the first confounder, X₁, and is included in the set of selected confounders X, in step 306.

Thereafter, steps 308 and 310 are iterated until all the remaining confounders are selected. In particular, in step 308, for all possible Cᵢ, MI (Cᵢ, O|T,X) is computed. For the i-th confounding variable Cᵢ, MI (Cᵢ,O|T, X) provides a measure of information that Cᵢ represents about the outcome, given the treatment as occurred and all the already selected confounders (events or properties) have been observed. As such, the Cᵢ that maximizes MI (Cᵢ, O|T, X) is chosen as the next confounder, Xⱼ, and is included in the set of selected confounders X, in step 310. In the first iteration of step 308, the set X contains X₁ only. In general, at the beginning of the j-th iteration, the set X contains X₁, X₂, . . . , Xⱼ₋₁. Thus, in this iteration, MI (Cᵢ, O|T,X) provides a measure of information that Cᵢ represents about the outcome, given the treatment as occurred and all the already selected confounders (X₁,X₂, . . . , Xⱼ₋₁) have been observed. At the end of the j-th iteration X={X₁, X₂, . . . , Xⱼ}. Thus, after N−1 iterations, the best N confounders, (X₁,X₂, . . . ,X_{N}), are identified.

The step 304 and each iteration of the step 308 involves up to |F| computations and, as discussed above, the number of observations |F| can be large. This number remains fixed, however, once the observations are collected. Given N, the sets of computations in steps 304 and 308 need to be performed only N times. As such, for a specified, desired number of confounders to be selected, N, the computations in the process 300 scale linearly, and not super linearly or exponentially. As such, compared to many other techniques for causal inferencing, the process 300 may require significantly less (e.g., one or more magnitudes of order less) computational resources.

### Major Step 3: Treatment Effect Estimation

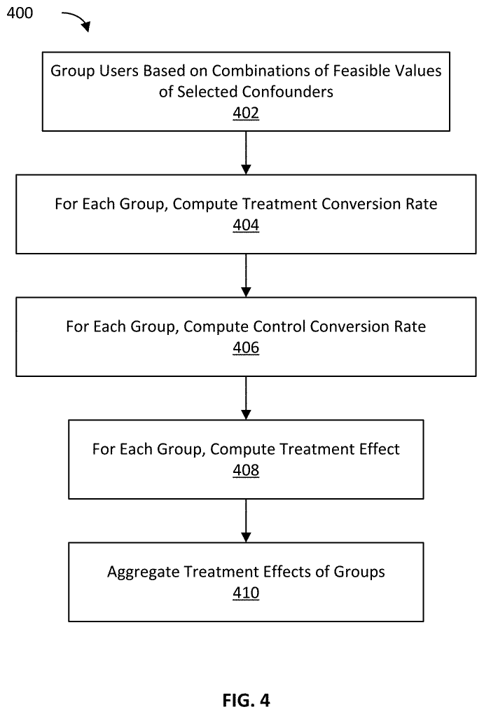

Once the confounding variables are selected, a matching model that uses these variables may be generated to calculate the average treatment effect. In particular, with reference to FIG. 4, in a treatment effect estimation process 400, users are grouped according to the combinations of the feasible values of the selected confounding variables, in step 402. Within each group, the treatment conversion rate is computed for the users who received/performed a treatment, in step 404. The treatment conversion rate is the ratio of the number of users who performed the desired or intended outcome to the number of users in the group that received/performed the treatment. In step 406, for each group, a control conversion rate is computed for the users that did not receive or perform the treatment. The control conversion rate is the ratio of the number of users who performed the outcome to the number of users in the group that did not receive or perform the treatment. In step 408, for each group, the treatment effect is computed as the difference between the respective treatment conversion rate and the respective control conversion rate. Thus, the treatment effect can quantify a difference that can be attributed to the treatment. The aggregate treatment effect is calculated in step 410, e.g., as a weighted average of the treatment effects computed for the groups, where the respective weights are the number of users in each group.

Table 2 shows example computations according the process 400. In this example, two confounders are considered. Confounder #1 is a Boolean variable that is set true or false depending on whether a user performed a particular event. Confounder #2 is a property (platform, in particular) of a user device that can be a web platform or a mobile platform. While the confounder #2 takes on only two values in this example, this is for illustration only. In general a confounder corresponding to a property can take on more than two (e.g., 3, 5, 10, etc.) values. In this example, four different combinations of confounder values are feasible, namely, (G1) <true, web>; (G2) <true, mobile>; (G3) <false, web>; and (G4) <false, mobile>.

TABLE 2
Treatment Effect Estimation

| | | | Treatment | Control | Treatment |
|---|---|---|---|---|---|
| Confounder #1 | Confounder #2 | Count | Conversion Rate | Conversion Rate | Effect |
| Did Perform | Platform is Web | 13242 | 36.3% | 54.2% | −17.9% |
| Event X | | | | | |
| Did Perform | Platform is | 5412 | 35.0% | 50.0% | −15.0% |
| Event X | Mobile | | | | |
| Did Not Perform | Platform is Web | 18032 | 17.8% | 2.3% | 15.5% |
| Event X | | | | | |
| Did Not Perform | Platform is | 3421 | 64.2% | 18.1% | 46.1% |
| Event X | Mobile | | | | |

| | |
|---|---|
| WEIGHTED AVERAGE | 2.97% |

Table 2 shows that of all the observed users, 13,242 belong to group G1. Within group G1, 36.3% of those who received/performed the treatment also performed the outcome, yielding a treatment conversion rate of 36.3%. Moreover, in Group G1, 54.2% of those who did not receive/perform the treatment nevertheless performed the outcome, yielding a control conversion rate of 54.2%. Thus, in group G1, on average the treatment decreased the outcome, as indicated by the negative treatment effect rate of −17.9%. As a counter example, in group G4, on average the treatment increased the outcome, as indicated by the positive treatment effect rate of 46.1%. The overall treatment effect, as a weighted average, was 2.97%.

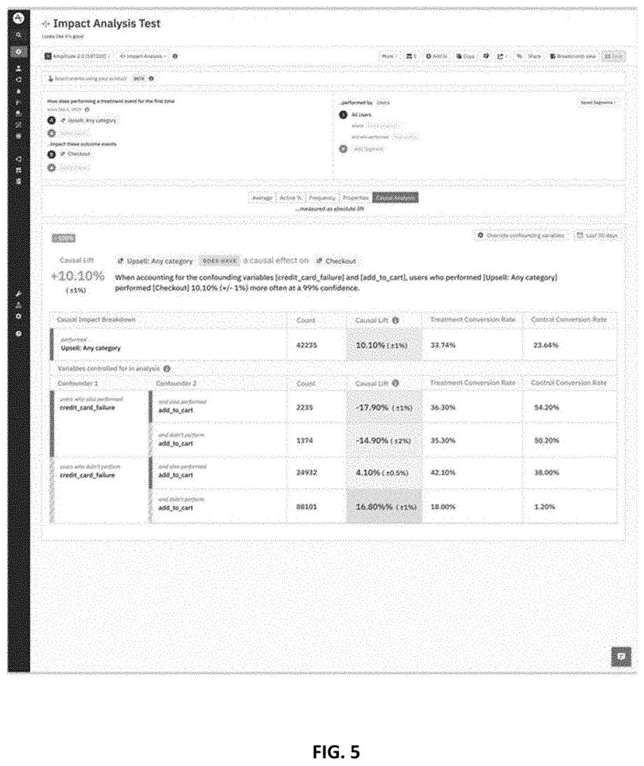

Table 2 provides additional insights, such as the treatment was generally more effective with respect to users who did not perform Event X relative to those who performed Event X. Furthermore, among those who did not perform Event X, the treatment was more effective, on average, for mobile users that it was for web users. Thus, unlike many other causal analysis techniques, various embodiments of the technique described herein can identify actual but latent confounding variables that can impact an outcome. This is further illustrated with reference to FIG. 5. The identification of the latent information can be valuable to an analyst because it can show how different subgroups of users may be affected differently by the same treatment, as discussed above. Based on the identification of this latent information, the user experience of different subgroups can be customized.

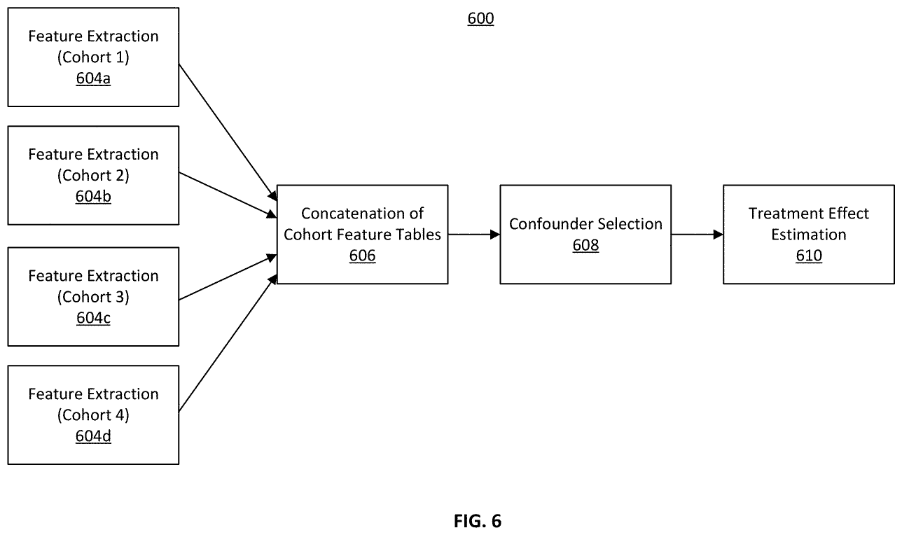

FIG. 6, is a block diagram of a system performing the three-step analysis described above. In the system 600, feature engineering (described above with reference to FIG. 1) is performed in module 602. In the module 602, features are extracted and respective feature tables are generated for the four cohorts 604a-604d. As discussed with reference to FIG. 1, these cohorts include: (1) User who did not receive/perform the treatment, and did not provide an outcome; (2) Users who did not receive/perform the treatment, but did provide the outcome; (3) Users who received/performed the treatment but did not provide the outcome; and Users who received the treatment/performed, and provided the outcome. Module 606 concatenates the respective features tables to form a comprehensive feature table. Memory may be allocated to store the comprehensive feature table as described above with reference to FIG. 2. A specified number of confounding variables are selected, as described above with reference to FIG. 3, in module 608. Using each selected confounding variable, treatment effect for a certain treatment-outcome pair may be determined, as described above with reference to FIG. 4, in module 610.

One technical advantage of the overall technique described herein is performing real-time, dynamically adjustable analysis. As used herein, real-time means within a few seconds, minutes, or hours, as opposed to after one or more days, weeks, etc. Some other causal inferencing techniques collect data from day 0 (e.g., the day of analysis) going back to day X, to determine which users performed the outcome, from day X going back to day Y, to determine which users received or performed the treatment, and from day Y going back to day Z, to obtain pre-treatment data. These techniques generally do not account for: (i) user who may have performed the outcome immediately after receiving or performing the treatment (e.g., during the period between days X and Y), (ii) events performed immediately before the treatment (e.g., during the period between days 0 and Y), and (iii) treatment received pr performed immediately before the outcome (e.g., during the period between days 0 and X). This can lead to an inaccurate analysis. Various embodiments described herein employ pre-treatment observation windows that may be dynamically adjusted for each user as a fraction of the overall observation window, as described above. This can allow collection of observations in real time, and can improve the accuracy of the analysis.

Another technical advantage, as discussed above, is the significant (e.g., one or more orders of magnitude) saving in computation resources in terms of the number of processors/cores required, the required processor time, the overall computation time, the required memory capacity, total energy consumption, etc., because the computation process 300 (FIG. 3) and the storage structure 200 (FIG. 2) used in the computations, both scale linearly with respect to the number of confounding variables/features observed (denoted |F|) in the discussion above, or with respect to the number (N) of the confounding variables to be selected for causal inferencing. As such, some implementations of the technique described herein can perform causal inferencing, where several (e.g., 10, 20, etc.) confounding variables are involved, in a few minutes as opposed to taking a few hours or even more.

A further technical advantage of the computationally efficient causal inferencing described herein is that it allows for the identification of conversion drivers. Specifically, rather than estimating the causal impact of just one treatment selected by an analyst, some embodiments can be run in batch mode and/or in parallel without exceeding memory capacity, to estimate the causal impact of several candidate treatments. The respective treatment effects for these treatments can be derived, and presented to the analyst as a rank ordered list of treatments, identifying those with the highest causal impacts.

Having now fully set forth the preferred embodiments and certain modifications of the concept underlying the overall technique, various other embodiments as well as certain variations and modifications of the embodiments herein shown and described will obviously occur to those skilled in the art upon becoming familiar with said underlying concept.

What is claimed is:

1. A computer-implemented method for inferring causal relationships, the method comprising:
collecting user interaction data for a plurality of users, within a specified observation window, the collected data comprising a treatment observation for at least one user and an outcome observation for at least one user;
allocating memory for a feature table, wherein a size the allocated memory is proportional to a number of features in the collected data;
storing in the feature table feature-related values based on respective pre-treatment observation periods for each of the plurality of users;
identifying a selected number of confounders from the feature table; and
computing an effect of the treatment on the outcome using the selected confounders.

2. The method of claim 1, wherein the collected data comprises one or more events indicative of user action or one or more properties of user devices.

3. The method of claim 1, wherein storing feature-related values in the feature table comprises:
partitioning the plurality of users into four cohort groups based on the treatment and the outcome;
generating respective feature tables for each cohort; and
concatenating the respective feature tables.

4. The method of claim 1, wherein the pre-treatment observation period for a first user is different from the pre-treatment observation for a second user.

5. The method of claim 1, wherein identifying the selected number of confounders comprises iteratively computing a mutual information measure between a feature and the outcome under a condition that the treatment and a previously selected set of confounders have occurred, wherein a number of iterations is one less than the selected number of confounders.

6. The method of claim 1, wherein computing the effect of the treatment on the outcome comprises:
grouping the plurality of users into one or more groups, wherein all users in a particular group have identical values for the selected confounders.

7. The method of claim 1, wherein the treatment comprises a stimulus provided to one or more of the plurality of users or a particular action taken by one or more of the plurality of user.

8. The method of claim 1, wherein the collected data corresponds to user interaction with a webpage, a mobile app, or a user interface.

9. A non-transitory computer readable medium containing computer-readable instructions stored therein for causing a computer processor to perform operations comprising:
collecting user interaction data for a plurality of users, within a specified observation window, the collected data comprising a treatment observation for at least one user and an outcome observation for at least one user;
allocating memory for a feature table, wherein a size the allocated memory is proportional to a number of features in the collected data;
storing in the feature table feature-related values based on respective pre-treatment observation periods for each of the plurality of users;
identifying a selected number of confounders from the feature table; and
computing an effect of the treatment on the outcome using the selected confounders.

10. The non-transitory computer readable medium of claim 9, wherein the collected data comprises one or more events indicative of user action or one or more properties of user devices.

11. The non-transitory computer readable medium of claim 9, wherein storing feature-related values in the feature table comprises:
partitioning the plurality of users into four cohort groups based on the treatment and the outcome;
generating respective feature tables for each cohort; and
concatenating the respective feature tables.

12. The non-transitory computer readable medium of claim 9, wherein the pre-treatment observation period for a first user is different from the pre-treatment observation for a second user.

13. The non-transitory computer readable medium of claim 9, wherein identifying the selected number of confounders comprises iteratively computing a mutual information measure between a feature and the outcome under a condition that the treatment and a previously selected set of confounders have occurred, wherein a number of iterations is one less than the selected number of confounders.

14. The non-transitory computer readable medium of claim 9, wherein computing the effect of the treatment on the outcome comprises:
grouping the plurality of users into one or more groups, wherein all users in a particular group have identical values for the selected confounders.

15. The non-transitory computer readable medium of claim 9, wherein the treatment comprises a stimulus provided to one or more of the plurality of users or a particular action taken by one or more of the plurality of user.

16. The non-transitory computer readable medium of claim 9, wherein the collected data corresponds to user interaction with a webpage, a mobile app, or a user interface.
